(19) United States
(12) Patent Application Publication
(10) Pub. No.: US 2013/0026864 A1
(43) Pub. Date: Jan. 31, 2013

(54) TRAVERSAL SWITCHED RELUCTANCE MOTOR

(71) Applicants: Han Kyung BAE, Gyunggi-do (KR); Changsung Sean KIM, Gyunggi-do (KR); Chang Hwan CHOI, Gyunggi-do (KR); Young Bok YOON, Gyunggi-do (KR)

(72) Inventors: Han Kyung BAE, Gyunggi-do (KR); Changsung Sean KIM, Gyunggi-do (KR); Chang Hwan CHOI, Gyunggi-do (KR); Young Bok YOON, Gyunggi-do (KR)

(73) Assignee: SAMSUNG ELECTRO-MECHANICS CO., LTD., Gyunggi-do (KR)

(21) Appl. No.: 13/327,016

(22) Filed: Dec. 15, 2011

(30) Foreign Application Priority Data
Jul. 29, 2011 (KR) 10-2011-0075922

(51) Int. Cl. H02K 19/10

(52) U.S. Cl. 310/46

(57) ABSTRACT

Disclosed herein is a transversal switched reluctance motor including: a rotor assembly formed by arranging a plurality of rotors including a rotor pole mounting part having a shaft coupled to an inner portion thereof and a plurality of rotor poles coupled to the rotor pole mounting part along an outer peripheral surface thereof in a direction of the shaft; and a stator assembly including a plurality of stators each including a coil enclosing an outer peripheral surface of the rotor assembly so that the rotor assembly is rotatably received in an inner portion thereof and a plurality of stator cores fitted with the coil from one side direction thereof along an outer peripheral surface thereof to thereby face the plurality of rotor poles, wherein the stator core has a C shaped cross section with respect to the direction of the shaft around which the rotor assembly rotates.

### CROSS REFERENCE TO RELATED APPLICATION

This application claims the benefit of Korean Patent Application No. 10-2011-0075922, filed on Jul. 29, 2011, entitled “Transverse Type Switched Reluctance Motor”, which is hereby incorporated by reference in its entirety into this application.

### BACKGROUND OF THE INVENTION

1. Technical Field

The present invention relates to a transversal switched reluctance motor.

2. Description of the Related Art

Recently, a demand for a motor has been largely increased in various industries such as vehicles, aerospace, military, medical equipment, or the like. In particular, a cost of a motor using a permanent magnet is increased due to the sudden price increase of a rare earth material, such that a switched reluctance motor (hereinafter, referred to as an SR motor) has become interested as a new alternative.

A driving principle of an SR motor rotates a rotor using a reluctance torque generated according to a change in magnetic reluctance.

Generally, the switched reluctance motor is configured to include a stator 10 including a plurality of fixing salient poles 11 and a rotor 20 including a plurality of rotating salient poles 22 facing the plurality of fixing salient poles 11 as shown in FIG. 1.

More specifically, the stator 10 is configured to include the plurality of fixing salient poles 11 protruded toward the rotor 20 at predetermined intervals in a circumferential direction of an inner peripheral surface of the stator 10 and coils 12 wound around each of the fixing salient poles 11. The rotor 20 is formed by stacking cores 21 from which the plurality of rotating salient poles 22 facing the respective fixing salient poles 11 are protruded at predetermined intervals in a circumferential direction.

In addition, a shaft 30 transferring driving force of the motor to the outside is coupled to the center of the rotor 20 to thereby integrally rotate together with the rotor 20.

Further, a concentrated type coil 12 is wound around the fixing salient poles 11. On the other hand, the rotor 20 is configured of only an iron core without any type of excitation device, for example, a winding of a coil or a permanent magnet.

Therefore, when a current flows in the coil 12 from the outside, reluctance torque moving the rotor 20 toward the coil 12 by magnetic force generated from the coil 12 is generated, such that the rotor 20 rotates in a direction in which resistance of a magnetic circuit is minimized.

On the other hand, the SR motor according to the prior art may lead to core loss since a magnetic flux path passes through both of the stator 10 and the rotor 20. In addition, driving force of the switched reluctance motor may be deteriorated due to the generation of the core loss.

### SUMMARY OF THE INVENTION

The present invention has been made in an effort to provide a transversal switched reluctance motor making a magnetic flux path short to reduce core loss.

Further, the present invention has been made in an effort to provide a transversal switched reluctance motor having improved driving force by including a rotor assembly and a stator assembly that may be stacked in plural and be easily expanded.

According to a first preferred embodiment of the present invention, there is provided a transversal switched reluctance motor including: a rotor assembly formed by arranging a plurality of rotors including a rotor pole mounting part having a shaft coupled to an inner portion thereof and a plurality of rotor poles coupled to the rotor pole mounting part along an outer peripheral surface thereof in a direction of the shaft; and a stator assembly including a plurality of stators each including a coil enclosing an outer peripheral surface of the rotor assembly so that the rotor assembly is rotatably received in an inner portion thereof and a plurality of stator cores fitted with the coil from one side direction thereof along an outer peripheral surface thereof to thereby face the plurality of rotor poles, wherein the stator core has a C shaped cross section with respect to the direction of the shaft around which the rotor assembly rotates.

The stator core may include: a stator core yoke that is in parallel with the rotor pole; a first stator core salient pole bent and protruded from one end of the stator core yoke toward the rotor pole; and a second stator core salient pole bent and protruded from the other end of the stator core yoke toward the rotor pole.

The coil may be disposed between a plurality of first stator core salient poles and a plurality of second stator core salient poles, such that the coil and the plurality of the stator cores are electrically connected to each other.

The coil may have a disc shape in which it includes a reception hole formed at the center thereof so that the rotor assembly is rotatably received in the inner portion thereof to thereby enclose the outer peripheral surface of the rotor assembly.

In the stator assembly, a plurality of stator cores configuring one stator facing the rotor assembly and a plurality of stator cores configuring another stator may be stacked in the same direction.

In the rotor assembly, a plurality of rotor poles coupled to an outer peripheral surface of one rotor pole mounting part and a plurality of rotor poles coupled to an outer peripheral surface of another rotor pole mounting part may be skewed from each other by a predetermined angle difference to thereby form a skew shape.

In the stator assembly, a plurality of stator cores configuring one stator facing the rotor assembly and a plurality of stator cores configuring another stator may be stacked in a direction in which they are skewed from each other by a predetermined angle difference to thereby form a skew shape.

In the rotor assembly, a plurality of rotor poles coupled to an outer peripheral surface of one rotor pole mounting part and a plurality of rotor poles coupled to an outer peripheral surface of another rotor pole mounting part may be stacked in the same direction.

According to a second preferred embodiment of the present invention, there is provided a transversal switched reluctance motor including: a rotor assembly formed by arranging a plurality of rotors including a rotor pole mounting part having a shaft coupled to an inner portion thereof and a plurality of rotor poles coupled to the rotor pole mounting part along an outer peripheral surface thereof in a direction of the shaft; and a stator assembly including a plurality of stators each including a plurality of stator cores having coils wound therearound multiple times, facing the plurality of rotor poles, and arranged in a circumferential direction of the rotor assembly so that the rotor assembly is rotatably received therein, wherein the stator core has a C shaped cross section with respect to the direction of the shaft around which the rotor assembly rotates.

The stator core may include: a stator core yoke that is in parallel with the rotor pole; a first stator core salient pole bent and protruded from one end of the stator core yoke toward the rotor pole; and a second stator core salient pole bent and protruded from the other end of the stator core yoke toward the rotor pole.

The coils may be wound around the stator core yoke multiple times.

The coils are wound around the first stator core salient pole or the second stator core salient pole multiple times.

In the stator assembly, a plurality of stator cores configuring one stator facing the rotor assembly and a plurality of stator cores configuring another stator may be stacked in the same direction.

In the rotor assembly, a plurality of rotor poles coupled to an outer peripheral surface of one rotor pole mounting part and a plurality of rotor poles coupled to an outer peripheral surface of another rotor pole mounting part may be skewed from each other by a predetermined angle difference to thereby form a skew shape.

In the stator assembly, a plurality of stator cores configuring one stator facing the rotor assembly and a plurality of stator cores configuring another stator may be stacked in a direction in which they are skewed from each other by a predetermined angle difference to thereby form a skew shape.

In the rotor assembly, a plurality of rotor poles coupled to an outer peripheral surface of one rotor pole mounting part and a plurality of rotor poles coupled to an outer peripheral surface of another rotor pole mounting part may be stacked in the same direction.

### BRIEF DESCRIPTION OF THE DRAWINGS

FIG. 1 is a plan view of a switched reluctance motor according to the prior art;

FIG. 2 is a schematic assembly perspective view of a transversal switched reluctance motor according to a first preferred embodiment of the present invention;

FIG. 3 is an exploded perspective view of a rotor assembly configuring the transversal switched reluctance motor shown in FIG. 2;

FIG. 4 is a cut-away assembly perspective view of a portion of the transversal switched reluctance motor shown in FIG. 2;

FIG. 5 is a schematic assembly perspective view of a transversal switched reluctance motor according to a second preferred embodiment of the present invention;

FIG. 6 is an exploded perspective view of a rotor assembly configuring the transversal switched reluctance motor shown in FIG. 5;

FIG. 7 is a cut-away assembly perspective view of a portion of the transversal switched reluctance motor shown in FIG. 5;

FIG. 8 is a perspective view showing another preferred embodiment of a stator core configuring the transversal switched reluctance motor according to the first and second preferred embodiments of the present invention; and

FIG. 9 is a perspective view showing another preferred embodiment of a stator core configuring the transversal switched reluctance motor according to the first and second preferred embodiments of the present invention.

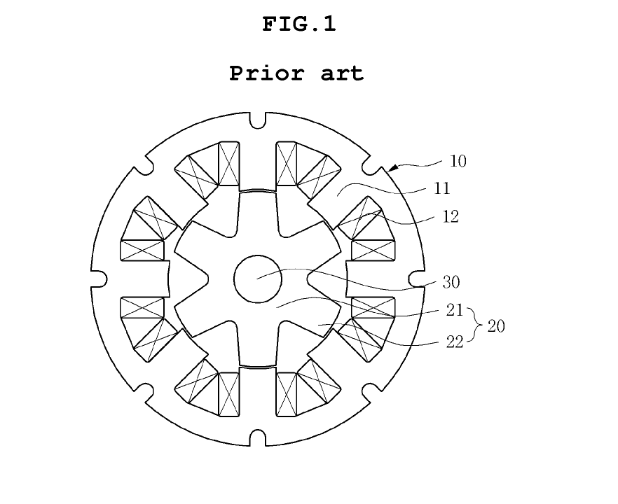

### DESCRIPTION OF THE PREFERRED EMBODIMENTS

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

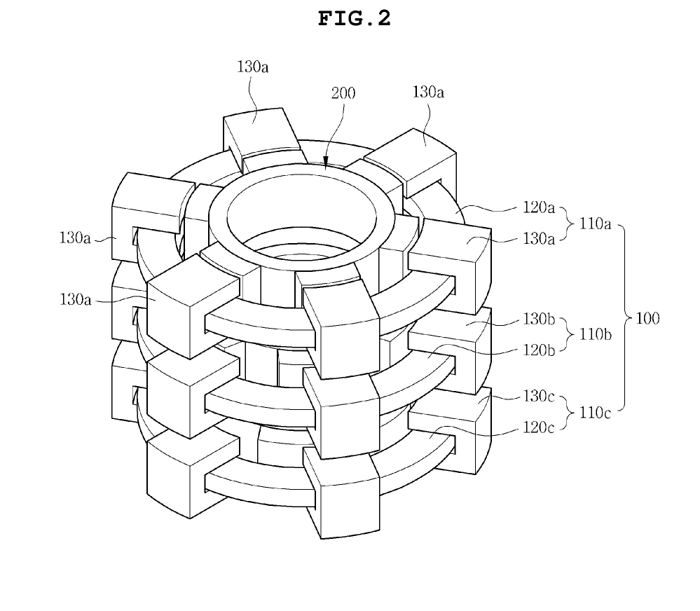

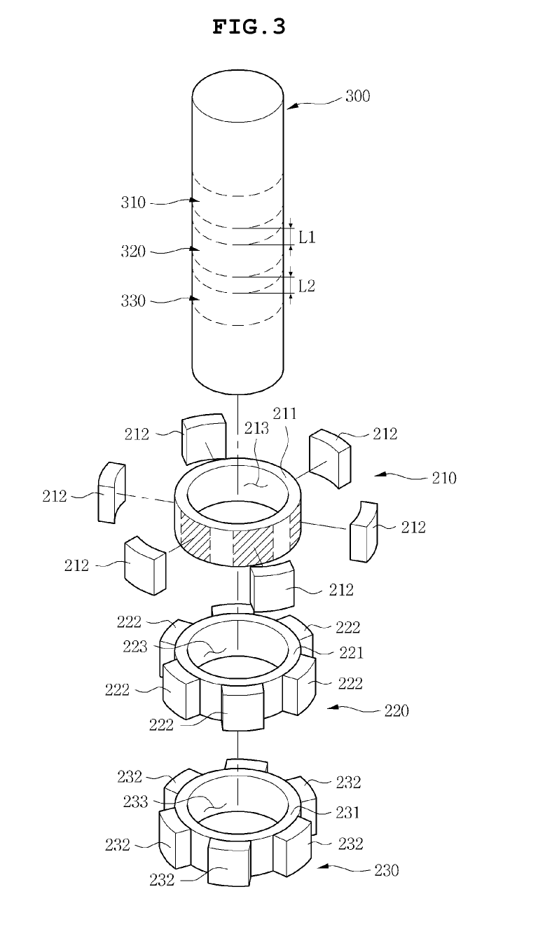

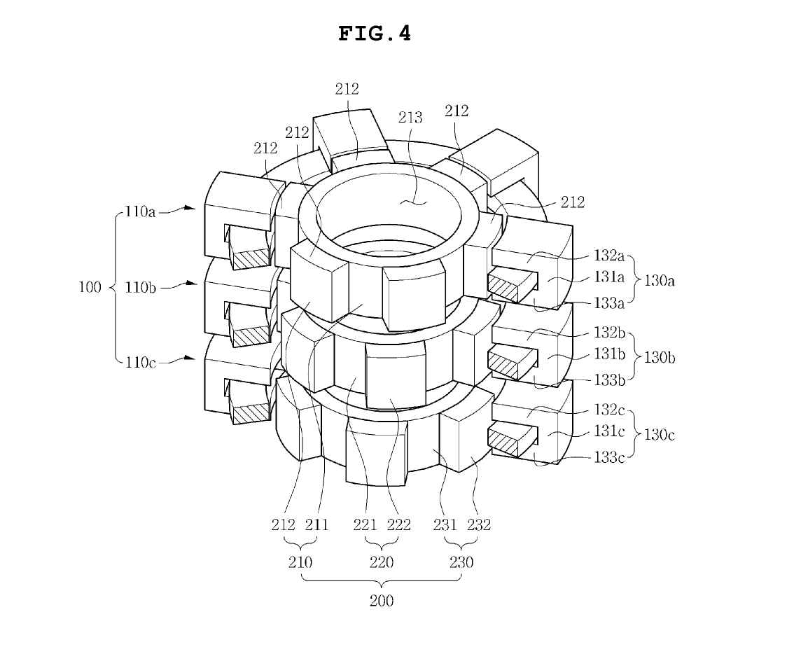

FIG. 2 is a schematic assembly perspective view of a transversal switched reluctance motor according to a first preferred embodiment of the present invention; FIG. 3 is an exploded perspective view of a rotor assembly configuring the transversal switched reluctance motor shown in FIG. 2; and FIG. 4 is a cut-away assembly perspective view of a portion of the transversal switched reluctance motor shown in FIG. 2.

As shown, a transversal switched reluctance motor according to a first preferred embodiment of the present invention includes a rotor assembly 200 and a stator assembly 100 rotatably receiving the rotor assembly 200 in an inner portion thereof.

As shown in FIG. 3, the rotor assembly 200 according to the first preferred embodiment of the present invention includes a plurality of rotors 210, 220, and 230 that are arranged in a direction of a shaft 280.

In addition, as shown, one rotor 210, another rotor 220, and the other rotor 230 have the same shape.

Therefore, the rotor 210 that is firstly coupled to the shaft 280 among the plurality of rotors 210, 220, and 230 as shown will be mainly described.

As shown, the rotor 210 includes a rotor pole mounting part 211 and a plurality of rotor poles 212.

More specifically, the rotor pole mounting part 211 has a cylindrical shape in which a hollow hole 213 is formed an inner portion thereof so that the shaft 280 is coupled to the inner portion thereof.

In addition, the plurality of rotor poles 212 are fixedly coupled to the rotor pole mounting part 211 along an outer peripheral surface thereof.

In addition, the rotor pole 212 is manufactured by stacking several sheets of iron core panels made of a metal material in a direction of the shaft 280. In addition, one surface of the rotor pole 212 facing the rotor pole mounting part 211 may be formed as a curved surface so that the rotor pole 212 is fixedly coupled to the rotor pole mounting part 211 having the cylindrical shape

In addition, as shown, six rotor poles 212 are fixedly coupled to the outer peripheral surface of the rotor pole mounting part 211 according to the first preferred embodiment of the present invention. Since the number of rotor poles coupled to the outer peripheral surface of the rotor pole mounting part increases or decreases according to a length of the outer peripheral surface of the rotor pole mounting part, it is not limited in the preferred embodiment of the present invention.

Further, as shown in FIG. 3, the plurality of rotors 210, 220, and 230 are arranged in the direction of the shaft 280. Particularly, one rotor 210 may be coupled to the shaft 280 in a state in which it is spaced apart from another rotor 220 by a predetermined interval.

More specifically, the rotor 210 firstly coupled to the shaft 280 is coupled to a first area 310 shown in a dotted line on the shaft 280.

In addition, the rotor 220 secondly disposed at the shaft 280 is coupled to a second area 320 shown in a dotted line on the shaft 280 in a state in which it is spaced apart from the first rotor 210 by a predetermined interval (L1).

In addition, the rotor 230 thirdly disposed at the shaft 280 is coupled to a third area 330 shown in a dotted line on the shaft 280 in a state in which it is spaced apart from the second rotor 220 by a predetermined interval (L2).

Therefore, magnetic resistance generated by an electromagnetic action between the rotor assembly 200 and the stator assembly 100 to be described below does not interfere in each rotor.

In addition, an insulating material such as a non-magnetic material or a resin material may be coupled to the above-mentioned intervals L1 and L2 in order to prevent a magnetic flux from moving from one rotor to another rotor.

As shown in FIG. 2, the stator assembly 100 rotatably receives the rotor assembly 200 in an inner portion thereof.

In addition, the stator assembly 100 includes a plurality of stators 110a, 110b, and 110c that are arranged in a direction of the shaft 280 so as to face the plurality of rotors 210, 220, and 230.

In addition, as shown, one stator 110a, another stator 110b, and the other stator 110c have the same shape.

Therefore, the stator 110a that is firstly arranged in the direction of the shaft 280 among the plurality of stators 110a, 110b, and 110c as shown will be mainly described. As shown, the stator 110a includes a coil 120a having a power applied from the outside thereto and a plurality of stator cores 130a.

More specifically, as shown in FIG. 4, the stator core 130a includes a stator core yoke 131a, a first stator core salient pole 132a, and a second stator core salient pole 133a.

In addition, the stator core yoke 131a may be formed to have a bar shape so that it is in parallel with the rotor pole 212 coupled to the outer peripheral surface of the rotor pole mounting part 211.

Further, the first stator core salient pole 132a is bent and protruded from one end of the stator core yoke 131 a toward the rotor pole 212.

Further, the second stator core salient pole 133a is bent and protruded from the other end of the stator core yoke 131a toward the rotor pole 212.

Therefore, the stator core 130a has a C or 1 shaped cross section with respect to the direction of the shaft 280 around which the rotor assembly 200 rotates.

In addition, the stator core 130a is fitted with the coil 120a from one side direction of the coil 120a so that the coil 120a is inserted into an interval between the first stator core salient pole 132a and the second stator core salient pole 133a.

Further, the coil 120a may have a disc shape in which it includes a reception hole formed at the center thereof so that the rotor assembly 200 is rotatably received in an inner portion thereof.

Therefore, the coil 120a is disposed to enclose an outer peripheral surface of the rotor assembly 200. In addition, according to the first preferred embodiment of the present invention, the coil 120a is electrically connected to the plurality of stator cores 130a configuring the stator 110a.

More specifically, since the plurality of stator cores 130a is fitted with the coil 120a from one side direction of the coil 120a as described above, the coil 120a is disposed in intervals between a plurality of first stator core salient poles 132a and a plurality of second stator core salient poles 133a.

As shown in FIGS. 3 and 4, according to the first preferred embodiment of the present invention, the plurality of rotor poles 212 coupled to the outer peripheral surface of one rotor pole mounting part 211 and the plurality of rotor poles 222 coupled to the outer peripheral surface of another rotor pole mounting part 221 are coupled to the shaft 280 so as to be arranged in a state in which they are skewed from each other by a predetermined angle difference.

More specifically, according to the first preferred embodiment of the present invention, six rotor poles 212 configuring a first layer, that is, the first rotor 210 and coupled to the outer peripheral surface of the rotor pole mounting part 211 and six rotor poles 222 configuring a second layer, that is, the second rotor 220 and coupled to the outer peripheral surface of the rotor pole mounting part 221 are arranged in a state in which they are skewed from each other by a predetermined angle difference to thereby form a skew shape.

In addition, six rotor poles 232 configuring a third layer, that is, the third rotor 230 and coupled to the outer peripheral surface of the rotor pole mounting part 231 and six rotor poles 222 configuring the second rotor 220 are also arranged in a state in which they are skewed from each other by a predetermined angle difference to thereby form a skew shape.

On the other hand, according to the first preferred embodiment of the present invention, the plurality of stator cores 130a configuring one stator 110a and the plurality of stator cores 130b configuring another stator 110b are stacked in the same direction. More specifically, according to the first preferred embodiment of the present invention, the plurality of stator cores 130b configuring the second stator 110b facing the second rotor 220 are coupled to the coil 120b so that they are disposed in the same straight line direction as the plurality of stator cores 130a configuring the first stator 110a.

In addition, the plurality of stator cores 130c configuring the other stator 110c, that is, the third stator 110c, disposed next to the second stator core 110b are also coupled to the third coil 120c so that they are disposed in the same straight line direction as the plurality of stator cores 130a configuring the first stator 110a described above and the plurality of stator cores 130b configuring the second stator 110b.

Driving of the transversal switched reluctance motor according to the first preferred embodiment of the present invention shown in FIGS. 2 to 4 will be described below.

First, when a power is applied only to the disc shaped coil 120a enclosing the outer peripheral surface of the first layer, that is, the first rotor 210, electromagnetic force is generated in the plurality of stator cores 130a connected to the coil 120a, such that the first stators 110a are excited.

Therefore, reluctance torque moving the rotor poles 212 configuring the first rotor 210 and coupled to the outer peripheral surface of the rotor pole mounting part 211 toward the stator cores 130a most adjacent thereto is generated, such that the rotor 210 rotates in a direction in which resistance of a magnetic circuit is minimized. Therefore, the first rotor 210 rotates, such that the rotor assembly 200 generally rotates.

Then, the supply of the power to the first layer of coil 120a is stopped, and the power is applied only to the second layer of coil 120b.

Therefore, the second rotor 220 rotates in the same scheme as the above-mentioned scheme, such that the rotor assembly 200 generally rotates. Next, the supply of the power to the second layer of coil 120b is stopped, and the power is applied only to the third layer of coil 120c.

Therefore, the transversal switched reluctance motor according to the first preferred embodiment of the present invention uses reluctance torque generated only in one layer, thereby making it possible to implement 3n phases (n indicates a natural number) according to the number of plurality of rotors arranged in the direction of the shaft 280 and the number of plurality of stators facing the plurality of rotors.

In addition, since a magnetic flux flows only in the stator core 130a having the C or shape and the rotor pole 212 coupled to the outer peripheral surface of the rotor pole mounting part 211, the transversal switched reluctance motor according to the first preferred embodiment of the present invention forms a magnetic flux path shorter as compared to the switched reluctance motor according to the prior art, thereby making it possible to reduce core loss.

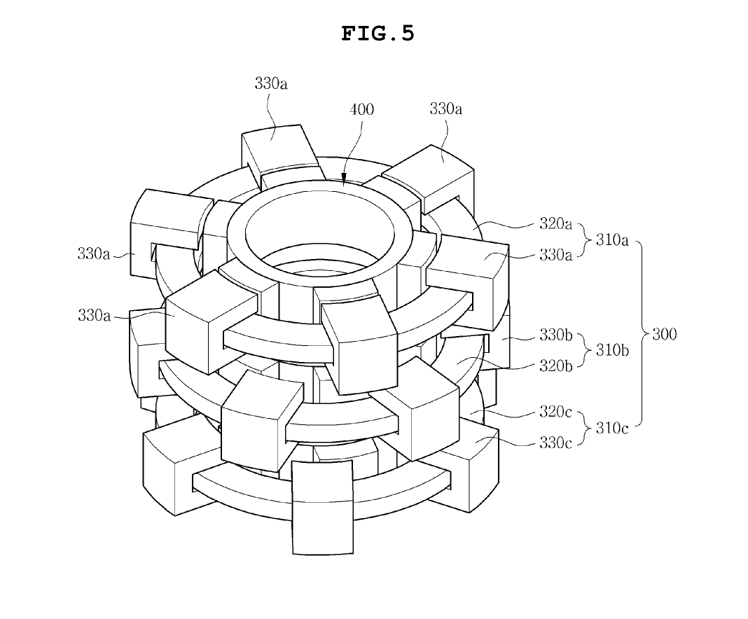

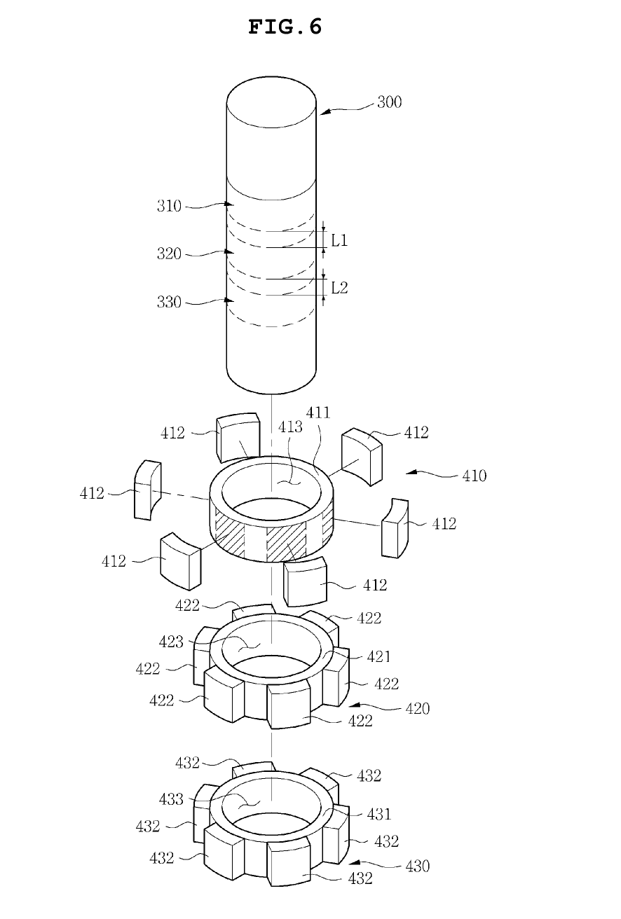

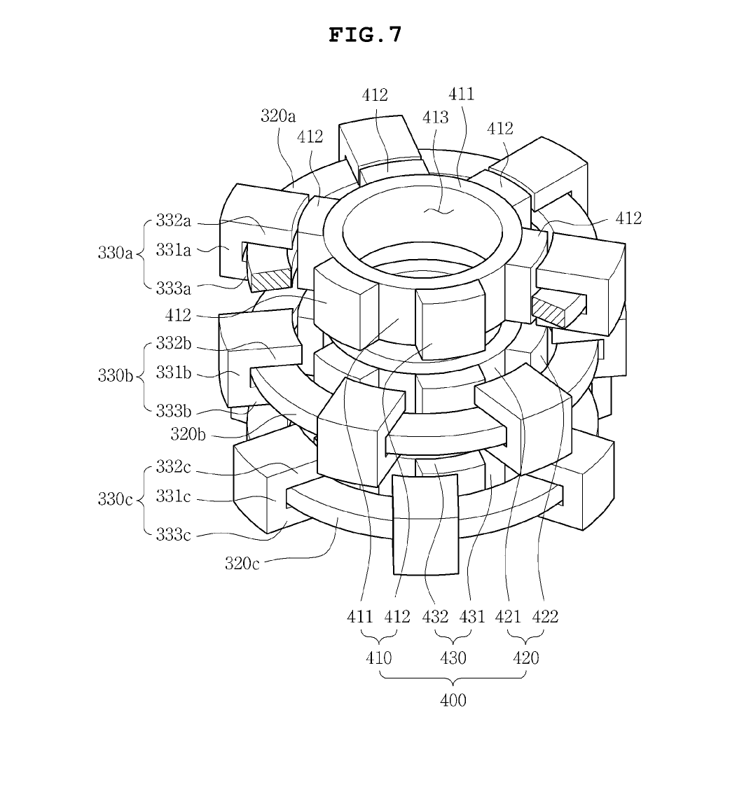

FIG. 5 is a schematic assembly perspective view of a transversal switched reluctance motor according to a second preferred embodiment of the present invention; FIG. 6 is an exploded perspective view of a rotor assembly configuring the transversal switched reluctance motor shown in FIG. 5; and FIG. 7 is a cut-away assembly perspective view of a portion of the transversal switched reluctance motor shown in FIG. 5. In describing the present embodiment, the same or corresponding components to the foregoing preferred embodiments are denoted by the same reference numerals and therefore, the description of the overlapping portions will be omitted. Hereinafter, a transversal switched reluctance motor according to the present embodiment will be described with reference to FIGS. 5 to 7.

As shown, a transversal switched reluctance motor according to a second preferred embodiment of the present invention includes a rotor assembly 400 and a stator assembly 300 rotatably receiving the rotor assembly 400 in an inner portion thereof.

As shown in FIG. 6, the rotor assembly 400 includes a plurality of rotors 410, 420, and 430 that are arranged in a direction of the shaft 280.

In addition, the rotor 410 includes a rotor pole mounting part 411 and a plurality of rotor poles 412.

Further, unlike the first preferred embodiment of the present invention described above, in the second preferred embodiment of the present invention, the plurality of rotor poles 412 coupled to an outer peripheral surface of one rotor pole mounting part 411 and the plurality of rotor poles 422 coupled to an outer peripheral surface of another rotor pole mounting part 421 are disposed in the same straight line direction.

More specifically, according to the second preferred embodiment of the present invention, six rotor poles 412 configuring a first layer, that is, the first rotor 410 and coupled to the outer peripheral surface of the rotor pole mounting part 411 and six rotor poles 422 configuring a second layer, that is, the second rotor 420 and coupled to the outer peripheral surface of the rotor pole mounting part 421 are disposed in the same straight line direction.

In addition, six rotor poles 432 configuring a third layer, that is, the third rotor 430 and coupled to the outer peripheral surface of the rotor pole mounting part 431 and six rotor poles 422 configuring the second rotor 420 are also disposed in the same straight line direction.

On the other hand, according to the second preferred embodiment of the present invention, the plurality of stator cores 330a configuring one stator 310a and the plurality of stator cores 330b configuring another stator 310b are arranged in a state in which they are skewed from each other by a predetermined angle difference. More specifically, according to the second preferred embodiment of the present invention, the plurality of stator cores 330b configuring the second stator 310b facing the second rotor 420 are coupled to the coil 320b so that they are arranged to be skewed from the plurality of stator cores 330a configuring the first stator 310a by a predetermined angle difference to thereby form a skew shape.

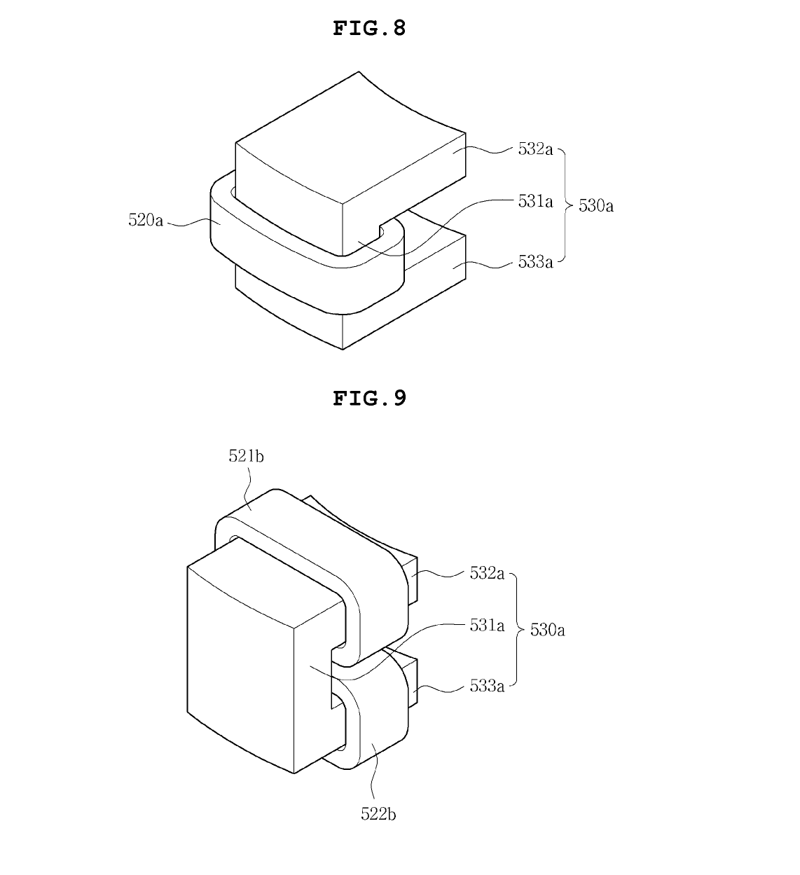

FIG. 8 is a perspective view showing another preferred embodiment of a stator core configuring the transversal switched reluctance motor according to the first and second preferred embodiments of the present invention; and FIG. 9 is a perspective view showing another preferred embodiment of a stator core configuring the transversal switched reluctance motor according to the first and second preferred embodiments of the present invention. In describing the present embodiment, the same or corresponding components to the foregoing preferred embodiments are denoted by the same reference numerals and therefore, the description of the overlapping portions will be omitted. Hereinafter, a transversal switched reluctance motor according to the present embodiment will be described with reference to FIGS. 8 and 9.

As shown, coils 520a wound around a stator core 530a according to the present embodiment are wound around a portion of the stator core 530a unlike the disc shaped coils according to the first and second preferred embodiments described above.

More specifically, the stator core 530a includes a stator core yoke 531a, a first stator core salient pole 532a, and a second stator core salient pole 533a.

In addition, the stator core yoke 531a may be formed to have a bar shape so that it is in parallel with the rotor pole coupled to the outer peripheral surface of the rotor pole mounting part.

Further, the first stator core salient pole 532a is bent and protruded from one end of the stator core yoke 531 a toward the rotor pole.

In addition, the second stator core salient pole 533a is bent and protruded from the other end of the stator core yoke 531 a toward the rotor pole. In addition, as shown in FIG. 8, the coils 520a may be wound around the stator core yoke 531a configuring the stator core 530a multiple times.

Further, as shown in FIG. 9, coils 521b and 522b may be wound around the first and second stator core salient poles 532a and 533a configuring the stator core 530a multiple times.

In addition, although FIG. 9 shows that the coils are wound around both of the first and second stator core salient poles 532a and 533a, the coils having a power applied from the outside thereto may also be selectively wound around any one of the first and second stator core salient poles 532a and 533a multiple times.

As set forth above, according to the preferred embodiment of the present invention, a transversal magnetic flux moving in parallel with the shaft is added to a magnetic flux path to make the magnetic flux path short, thereby making it possible to reduce core loss.

In addition, the rotor assembly and the stator assembly that may be stacked in plural and be easily expanded are provided, thereby making it possible to variously change driving force of the transversal switched reluctance motor.

Further, the transversal switched reluctance motor is set modularized, thereby making it possible to variously expand the transversal switched reluctance motor so as to be appropriate for the magnitude of torque demanded by a component having the transversal switched reluctance motor mounted therein.

Although the preferred embodiments of the present invention have been disclosed for illustrative purposes, they are for specifically explaining the present invention and thus a transversal switched reluctance motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A transversal switched reluctance motor comprising:
a rotor assembly formed by arranging a plurality of rotors including a rotor pole mounting part having a shaft coupled to an inner portion thereof and a plurality of rotor poles coupled to the rotor pole mounting part along an outer peripheral surface thereof in a direction of the shaft; and
a stator assembly including a plurality of stators each including a coil enclosing an outer peripheral surface of the rotor assembly so that the rotor assembly is rotatably received in an inner portion thereof and a plurality of stator cores fitted with the coil from one side direction thereof along an outer peripheral surface thereof to thereby face the plurality of rotor poles,
wherein the stator core has a C shaped cross section with respect to the direction of the shaft around which the rotor assembly rotates.

2. The transversal switched reluctance motor as set forth in claim 1, wherein the stator core includes:
a stator core yoke that is in parallel with the rotor pole;
a first stator core salient pole bent and protruded from one end of the stator core yoke toward the rotor pole; and
a second stator core salient pole bent and protruded from the other end of the stator core yoke toward the rotor pole.

3. The transversal switched reluctance motor as set forth in claim 2, wherein the coil is disposed between a plurality of first stator core salient poles and a plurality of second stator core salient poles, such that the coil and the plurality of the stator cores are electrically connected to each other.

4. The transversal switched reluctance motor as set forth in claim 3, wherein the coil has a disc shape in which it includes a reception hole formed at the center thereof so that the rotor assembly is rotatably received in the inner portion thereof to thereby enclose the outer peripheral surface of the rotor assembly.

5. The transversal switched reluctance motor as set forth in claim 1, wherein in the stator assembly, a plurality of stator cores configuring one stator facing the rotor assembly and a plurality of stator cores configuring another stator are stacked in the same direction.

6. The transversal switched reluctance motor as set forth in claim 5, wherein in the rotor assembly, a plurality of rotor poles coupled to an outer peripheral surface of one rotor pole mounting part and a plurality of rotor poles coupled to an outer peripheral surface of another rotor pole mounting part are skewed from each other by a predetermined angle difference to thereby form a skew shape.

7. The transversal switched reluctance motor as set forth in claim 1, wherein in the stator assembly, a plurality of stator cores configuring one stator facing the rotor assembly and a plurality of stator cores configuring another stator are stacked in a direction in which they are skewed from each other by a predetermined angle difference to thereby form a skew shape.

8. The transversal switched reluctance motor as set forth in claim 7, wherein in the rotor assembly, a plurality of rotor poles coupled to an outer peripheral surface of one rotor pole mounting part and a plurality of rotor poles coupled to an outer peripheral surface of another rotor pole mounting part are stacked in the same direction.

9. A transversal switched reluctance motor comprising:
a rotor assembly formed by arranging a plurality of rotors including a rotor pole mounting part having a shaft coupled to an inner portion thereof and a plurality of rotor poles coupled to the rotor pole mounting part along an outer peripheral surface thereof in a direction of the shaft; and
a stator assembly including a plurality of stators each including a plurality of stator cores having coils wound therearound multiple times, facing the plurality of rotor poles, and arranged in a circumferential direction of the rotor assembly so that the rotor assembly is rotatably received therein,
wherein the stator core has a C shaped cross section with respect to the direction of the shaft around which the rotor assembly rotates.

10. The transversal switched reluctance motor as set forth in claim 9, wherein the stator core includes:
a stator core yoke that is in parallel with the rotor pole;
a first stator core salient pole bent and protruded from one end of the stator core yoke toward the rotor pole; and
a second stator core salient pole bent and protruded from the other end of the stator core yoke toward the rotor pole.

11. The transversal switched reluctance motor as set forth in claim 10, wherein the coils are wound around the stator core yoke multiple times.

12. The transversal switched reluctance motor as set forth in claim 10, wherein the coils are wound around the first stator core salient pole or the second stator core salient pole multiple times.

13. The transversal switched reluctance motor as set forth in claim 9, wherein in the stator assembly, a plurality of stator cores configuring one stator facing the rotor assembly and a plurality of stator cores configuring another stator are stacked in the same direction.

14. The transversal switched reluctance motor as set forth in claim 13, wherein in the rotor assembly, a plurality of rotor poles coupled to an outer peripheral surface of one rotor pole mounting part and a plurality of rotor poles coupled to an outer peripheral surface of another rotor pole mounting part are skewed from each other by a predetermined angle difference to thereby form a skew shape.

15. The transversal switched reluctance motor as set forth in claim 9, wherein in the stator assembly, a plurality of stator cores configuring one stator facing the rotor assembly and a plurality of stator cores configuring another stator are stacked in a direction in which they are skewed from each other by a predetermined angle difference to thereby form a skew shape.

16. The transversal switched reluctance motor as set forth in claim 15, wherein in the rotor assembly, a plurality of rotor poles coupled to an outer peripheral surface of one rotor pole mounting part and a plurality of rotor poles coupled to an outer peripheral surface of another rotor pole mounting part are stacked in the same direction.
